(19) United States
(12) Patent Application Publication
(10) Pub. No.: US 2010/0262561 A1
(43) Pub. Date: Oct. 14, 2010

(54) System and method for modeling and implementing an employee benefit plan

(76) Inventor: Rudolph A. Cecchi, Miami, FL (US)

Correspondence Address: THE MILLER LAW OFFICES, PLC, 801 BRICKELL AVE, SUITE 900, MIAMI, FL, 33131, US

(21) Appl. No.: 12/687,866

(22) Filed: Jan. 14, 2010

Related U.S. Application Data
(63) Continuation of application No. 10/741,982, filed on Dec. 19, 2003, now abandoned.
(60) Provisional application No. 60/435,675, filed on Dec. 20, 2002.

(51) Int. Cl. G06Q 40/00; G06Q 10/00

(52) U.S. Cl. 705/36 R

(57) ABSTRACT

A process for determining the optimal premium structure and a lucrative retirement and a death benefit plan, provided by an employer to an employee, using a portion of the employee's contribution and the employer's contribution to finance the premium.

### CROSS REFERENCE TO RELATED APPLICATIONS

This application is a Continuation of, and claims priority from, U.S. application Ser. No. 10/741,982 filed on Dec. 19, 2003, which claimed priority U.S. Provisional Application Nos. 60/435,675 and 60/494,869 filed Dec. 20, 2002 and Aug. 12, 2003, respectively, whose entire contents are hereby incorporated by reference.

### BACKGROUND OF THE INVENTION

1. Field of the Invention

The system described below relates to modeling and implementation of an employee benefit program to provide designated employees with supplemental income benefits during the retirement years.

2. General Background

In an effort to attract and retain top-level employees, employers have recognized the necessity of providing superior benefit programs and assisting these employees with their retirement planning needs. Typical retirement programs fall short of meeting the retirement needs of highly compensated employees.

Studies have indicated that retired employees will require 60 to 70 percent of their pre-retirement income in their post-retirement years. Due to the limitations imposed on qualified plans by governmental regulation, these goals may not be attained. Therefore, to meet these objective, supplemental retirement programs are placed in effect. These supplemental plans have taken various shapes over the years.

The most common plan is a non-qualified deferred compensation plan (DCP) or supplemental retirement plan (SERP). These plans may either be financed by earmarking assets or not financed and carried as a liability of the employer. Typically these plans are treated as a non-deductible expense. The employer must book the liability but does not get an actual tax deduction until the retirement benefits are paid to the employee. The employee is also at risk that the employer will not be able to meet its obligations under the plan.

Accordingly, what is needed is a system and a method which implements a plan that overcomes these deficiencies.

### SUMMARY

The system disclosed in the preferred embodiment can be implemented in a computer system which will permit the employee benefit plan designers and the participating companies, such as insurance companies and investment management firms, to communicate through a network.

Furthermore, in one embodiment, the system will allow the plan designer to select the exact cost structure to meet the target benefit goals by analyzing insurance company policy structures under different premium scenarios as well as investment company product offerings under different contribution scenarios. Employer cash flow and profit and loss statements will also be produced to demonstrate the financial effects of the program to the plan sponsor.

The system described is designed to provide the employer with a current tax deduction, remove the liability from its books, and secure the benefit from the claims of its creditors. Moreover, the system may provide a virtual or simulated DCP or SERP. Using the employee's after-tax compensation, the system calculates the employer's required contribution to the plan to meet the targeted retirement goals. Once that amount is determined, two policies (e.g., life insurance policies) may be purchased. One policy is owned by the employee and is paid for with his or her after tax compensation, whereas the other policy is owned by the employer and is paid for with an amount approximating its tax savings from making the tax-deductible compensation payment to the employee. The investment approach uses mutual funds or managed accounts in a similar fashion.

The system therefore assures that there will be sufficient assets between the two policies to meet the employee's retirement needs. Upon termination of employment, the employer will be reimbursed for its contributions to its policy and distribute the policy and its remaining values to the executive (employee) in the form of a bonus with a gross-up for taxes. If the employee should die while employed, his or her heirs would receive proceeds from the policy owned individually. The employer's policy would pay the insurance proceeds to the employer which would then be in a position to pay a death benefit to the employee's designated beneficiary if desired. The mutual fund or managed account approach works by substituting these investments for the policies mentioned above.

The system or plan described can also be structured to provide joint ownership in a single policy, which is owned by both the employer and employee. Furthermore, the system can be structured with the employer contributing loans or bonuses to the employee's policy, which are targeted to achieve the same benefit levels without actually purchasing an employer owned policy. Each of these approaches has different cash flow and P&L results to the employer.

Utilizing the system allows employers to provide meaningful retirement and death benefits to their employees. The plan provides significant cash flow. P&L, and benefit security advantages heretofore unavailable in the employer/employee relationship. The plan may also serve to attract and retain talented employees by providing incentives to accept and maintain employment.

The system provides a solution to the problems associated with retirement benefit planning for persons such as highly compensated employees. Distinct advantages are provided to both the employer and employee.

The plan finances an employer's retirement benefit obligations and enables an employee to participate in such funding with his or her own dollars. It also may provide both pre- and post-retirement death benefits to the employee and may also provide pre-retirement death benefits to employers. These employer death benefits can offset some of the costs involved with replacing deceased employees and can also be used to provide additional death benefits to deceased employees' heirs. Uniquely, the plan described herein also protects plan assets from attachment by employer creditors and in certain jurisdictions, the creditors of the employee.

Accordingly, in one aspect of the plan, a method implemented in a computer program for providing benefits to an employee through a life insurance policy, comprises: (i) providing a premium structure between an employer and an employee, for a jointly owned insurance policy account, as an input to a computer program, (ii) determining and crediting non-taxable earnings for the account based on a credit rate, the jointly owned insurance policy account including at least one sub-account for the employee to invest the premium to generate the non-taxable earnings, (iii) wherein a net amount in the account is available for crediting to a beneficiary upon at least one of a retirement, termination of employment, or death of the employee. The net amount may include the non-taxable earnings generated in the account. Furthermore, the method may include the step of including a bonus available for crediting to a beneficiary upon termination of employment, wherein the bonus corresponds to the tax on the cash-surrender value for the account.

In another aspect of the system, a method for implementing a premium structure between an employer and employee, that is implemented in a computer program, for providing benefits related to two individual life insurance policies on the life of the employee, a first policy owned by the employer, and a second policy owned by the employee, comprises determining and crediting nontaxable earnings for each account based on a credit rate, the policies' accounts including a least one sub-account for the employer and employee to invest their respective premium to generate the non-taxable earnings, wherein a net amount in the employee's account is available for crediting to a beneficiary upon at least one of a retirement, termination of employment, or death of the employee. Additionally, the net amount in the employer's account is available for crediting to the employer's financial results, and upon retirement of the employee, the employer could recoup it's cost of the policy and thereafter distribute such policy as compensation to the employee unless the employee is terminated for cause or dies. Thus, the death benefit (viz., life insurance proceeds) is payable for the benefit of the employer and thereafter as a death benefit payable to the employee's beneficiary upon death of the employee. The computer program, one way to implement the method, includes features for, (i) applying an appropriate crediting rate to the policy, (ii) determining the death benefit payable to the employer and thereafter to the employee's beneficiary, (iii) determining the recovery amount of the employer's investment in the policy, (iv) determining the employee's beneficiary that receives a death benefit from the employer, (v) determining the distributions that the employee receives from the employee's policy, (vi) determining the distributions that the employee receives from the employer's policy, (vii) determining the distributions that the employee receives from the policy that was provided to the employee by the employer, (viii) computing a bonus occasioned by the employer's distribution of the policy to the employee upon termination, wherein the bonus corresponds to the tax on the cash surrender value for the policy which was distributed to the employee.

In yet another aspect of the system, a method for implementing a premium structure between an employer and employee, in a computer program, for providing benefits related to a single policy approach with two interests in the policy, wherein one interest is owned by the employee and the another interest is owned by the employer comprises: determining and crediting nontaxable earnings for each account based on a credit rate, said policies' accounts including a least one sub-account for the employer and employee to invest their respective premium to generate the non-taxable earnings. The net amount in the employee's account is available for crediting to a beneficiary upon at least one of a retirement, termination of employment, or death of the employee and a net amount in the employer's account is available for crediting to it's financial results. Upon retirement of the employee, the employer could recoup its cost of the policy and thereafter distribute such policy as compensation to the employee unless the employee is terminated for cause or dies. Additionally, the death benefit (or life insurance proceeds) are payable for the benefit of the employer and thereafter as a death benefit payable to the employee's beneficiary upon death of the employee.

In yet another aspect of the plan, a method for implementing a retirement benefit program using a computer system comprises: (i) determining an amount in excess over an employer premium in an employer policy at retirement or termination of employment, (ii) determining a total cash value of an employee policy, based on an employee premium, at the retirement or termination of employment, (iii) computing a maximum amount available for withdrawal from the total cash value of the employee policy at the retirement or termination of employment, and (iv) computing a weighted sum, wherein the weighted sum is obtained from the amount in excess over the employer premium in the employer policy and the maximum amount available for withdrawal from the total cash value of the employee policy, the weighted sum being a retirement benefit amount for the employee. The method may also include the steps of (a) determining a cash value increase, at retirement or termination, on the employer policy based on an annual premium contributed to the employer policy, (b) subtracting the annual premium contributed by the employer from the cash value increase to form the amount in excess over the premium amount in the employer policy at retirement or termination of employment, (c) contributing the employer premium into the employer policy on an annual basis, (d) contributing the employee premium into the employee policy on an annual basis, wherein the employee premium contribution is an after tax contribution, (e) computing a tax on the amount in excess over the employer premium, (f) determining an employer tax due on policy gain, wherein the employer tax due on policy gain is determined from the tax applied to a difference between the employer premium and the cash value increase in the employer policy, (g) determining a double bonus of employer's interest to employee, wherein the double bonus is determined from an employee tax rate and the employer tax rate, and wherein the double bonus=(employer tax due on policy gain)/[(x1)*(1−x2)], wherein x1=employer tax rate, and x2=employee tax rate, (h) determining a tax benefit from the double bonus to the employee, wherein the tax benefit=(employer tax due on policy gain)*(employee tax rate). [All uses of * in this application denote a multiplicative operation.]

In yet another aspect of the system, a method for implementing a death benefit program for an employee before retirement using a computer system, comprises: (i) determining an employer policy death benefit amount based on an employer annual premium, (ii) determining an employee life insurance policy death benefit amount for the employee based on an employee annual premium, (iii)computing a before retirement death benefit amount from the employer policy death benefit amount, the employee policy death benefit amount, and an employee tax rate, wherein the after retirement death benefit amount=a1+[(a2−a3)*(1−a4)], wherein al is the employee policy death benefit amount assigned to the employee, a2 is the employee policy death benefit amount, a3 is the employer annual premium, and a4 is the employee tax rate.

In yet another embodiment of the system, a method for implementing an employee retirement and death benefit program through a mutual fund, comprises: (i) determining an annual mutual fund contribution by the employee to the mutual fund, (ii) computing an employee mutual fund account value at retirement or death, wherein the employee mutual fund account value is the retirement or death benefit provided to a beneficiary of the employee upon retirement or death of the employee. The annual mutual fund contribution=[g1]*(1−g2), where g1 is a contribution amount provided by the employee into the mutual fund account and g2 is an employee income tax rate. The employee mutual fund account value at retirement=(k1+k2)*(1+k3), where k1 an employee mutual fund account value in the year prior to retirement, k2 is annual mutual fund contribution, and k3 is a mutual fund earnings rate. The plan provides for the creation of a hypothetical deferred compensation account to be administered by the employer. The employer contribution to the employee's mutual fund account is determined with reference to the employee's hypothetical deferred compensation account. To the extent that there is a shortfall in the account balance of the employee's mutual fund account, on an after tax basis, when compared to the hypothetical account, the employer's contribution to the employee's mutual fund account will be equal to such shortfall.

### BRIEF DESCRIPTION OF THE DRAWINGS

FIG. 1 is one embodiment of the system showing an employee benefit plan where the employer and the employee own a single policy;

FIG. 2 depicts the benefits being passed to the employee beneficiary after termination or death of employee for the plan of FIG. 1;

FIG. 3 is a numerical example of the premium structure for the plan, according to one embodiment of the system, of FIG. 1;

FIG. 4 is an exemplary spreadsheet of the cash flow analysis with the embodiment of FIG. 1;

FIG. 5 is an exemplary spreadsheet comparing the employee benefit analysis of the embodiment of FIG. 1 with the Employer Deferral Plan (EDP);

FIG. 6 is an exemplary spreadsheet of the P&L impact and balance sheet analysis with the embodiment of FIG. 1;

FIG. 7 is an exemplary spreadsheet for comparing the cash flow and P&L analysis between the embodiment of FIG. 1 and other benefit plans;

FIG. 8 is an exemplary chart depicting the advantages, for the employee, of the embodiment of FIG. 1 over other benefit plans;

FIG. 9 is an exemplary chart depicting the advantages, in terms of the corporate cash flow analysis, of the embodiment of FIG. 1 over other benefit plans;

FIG. 10 is an exemplary chart depicting the advantages, in terms of the corporate P&L impact analysis, of the embodiment of FIG. 1 over other benefit plans;

FIG. 11 is an exemplary chart depicting the advantages, in terms of the lump-sum after tax cash benefit to the employee, of the embodiment of FIG. 1 over other benefit plans;

FIG. 12 is an exemplary graph depicting the advantages, in terms of after-tax benefit paid to the employee's beneficiary, of the embodiment of FIG. 1 over other benefit plans;

FIG. 13 is another embodiment of the system showing an employee benefit plan with a two-individual policies approach;

FIG. 14 depicts the benefits being passed to the employee beneficiary after termination or retirement of the employee for the plan of FIG. 13;

FIG. 15 depicts the benefits being passed to the employee beneficiary after death of the employee for the plan of FIG. 13;

FIG. 16 is a numerical example of the premium investment structure of the plan of FIG. 13;

FIG. 17 is an exemplary chart depicting the advantages, for the employee, of the embodiment of FIG. 13 over other benefit plans;

FIG. 18 is an exemplary chart depicting the advantages, in terms of the corporate cash flow analysis, of the embodiment of FIG. 13 over other benefit plans;

FIG. 19 is an exemplary chart depicting the advantages, in terms of the corporate P&L impact analysis, of the embodiment of FIG. 13 over other benefit plans;

FIG. 20 is an exemplary chart depicting the advantages, in terms of the lump-sum after tax cash benefit to the employee, of the embodiment of FIG. 13 over other benefit plans;

FIG. 21 is an exemplary chart depicting the advantages, in terms of after-tax benefit paid to the employee's beneficiary, of the embodiment of FIG. 13 over other benefit plans;

FIG. 22 is an exemplary spreadsheet of the cash flow analysis with the embodiment of FIG. 13;

FIG. 23 is an exemplary spreadsheet of the P&L impact and balance sheet analysis with the embodiment of FIG. 13;

FIG. 24 is an exemplary spreadsheet for comparing the cash flow and P&L analysis between the embodiment of FIG. 13 and other benefit plans;

FIG. 25 is an exemplary spreadsheet for comparing the employee benefit analysis between the embodiment of FIG. 13 and the EDP;

FIG. 26 is another embodiment of the system showing an employee benefit plan with a mutual fund approach;

FIG. 27 depicts the benefits being passed to the employee beneficiary after termination or retirement of the employee for the plan of FIG. 26;

FIG. 28 is an exemplary spreadsheet of the cash flow analysis with the embodiment of FIG. 26;

FIG. 29 is an exemplary spreadsheet of the P&L impact and balance sheet analysis with the embodiment of FIG. 26;

FIG. 30 is an exemplary chart comparing the employee benefit analysis between the Mutual Fund approach of FIG. 26 and the EDP.

### DESCRIPTION OF THE PREFERRED EMBODIMENTS

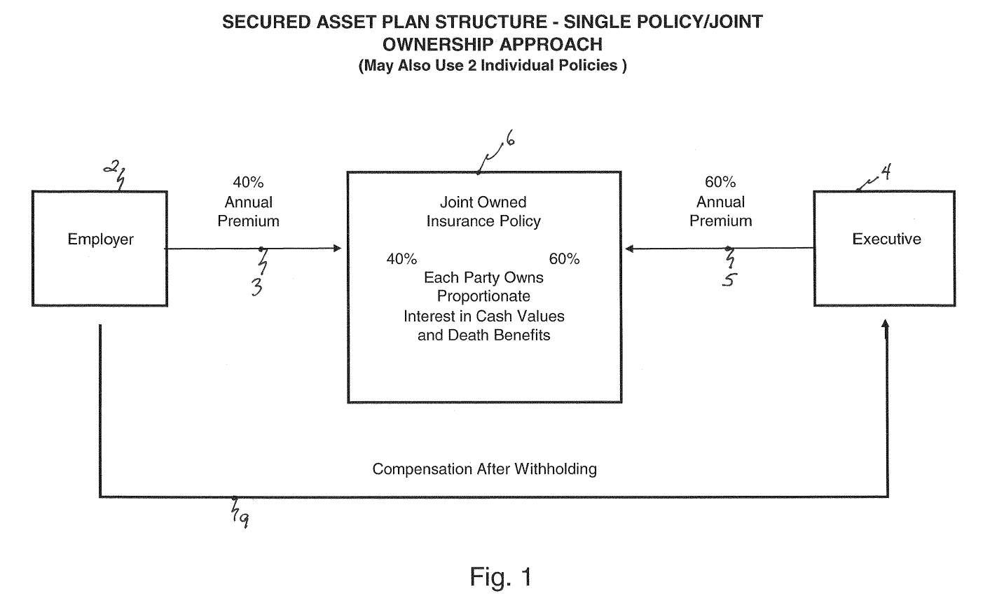

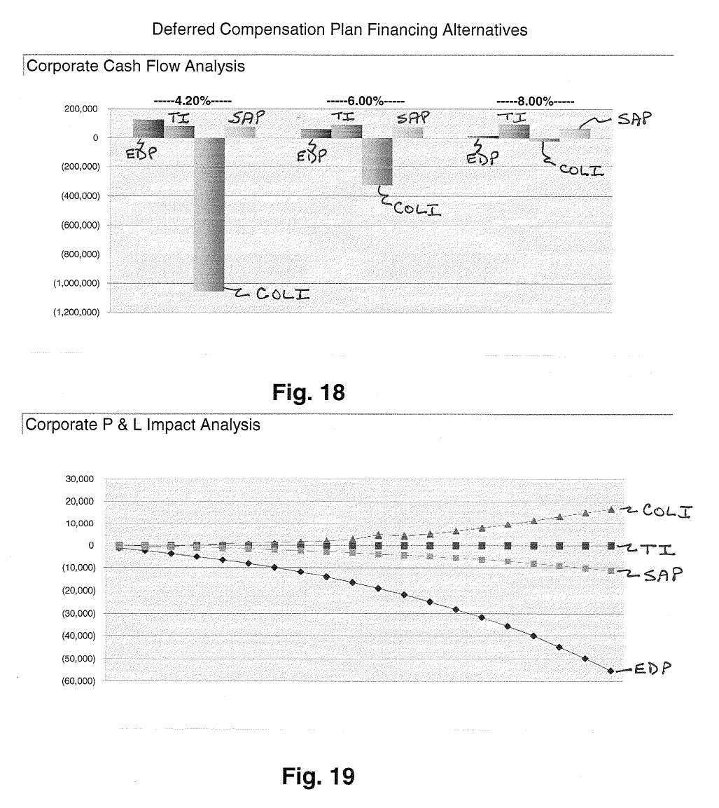

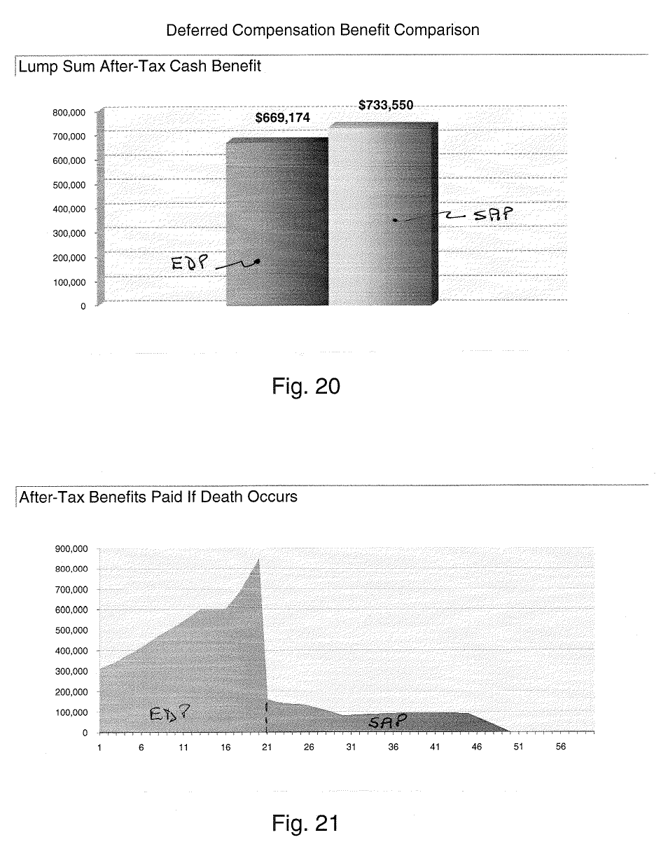

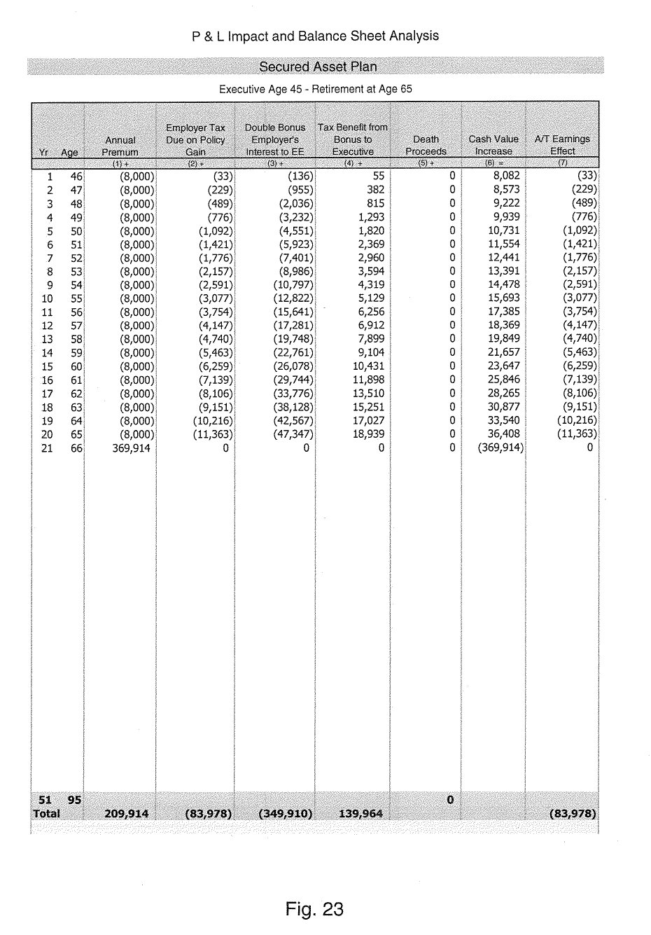

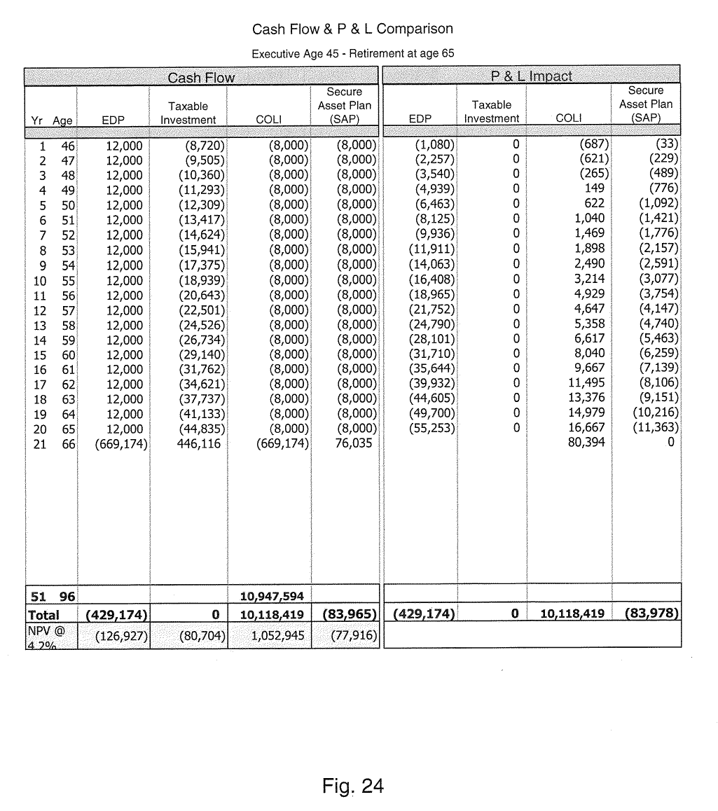

The attached description of exemplary and anticipated embodiments, as depicted through FIGS. 1-30, of the system have been presented for the purposes of illustration and description. They are not intended to be exhaustive or to limit the invention to the precise forms disclosed. Many modifications and variations are possible in light of the teachings herein.

Reference will now be made in detail to an exemplary embodiment of the system, an example which is illustrated in the accompanying drawing (FIGS. 1-30).

FIG. 1 is one embodiment of the system showing an employee benefit plan where the employer and the employee own a single policy 6. Specifically, the benefit plan includes a joint ownership of an employee benefit plan 6 (e.g., a life insurance policy). Generally, the premium structure of the plan may be designed such that, from the bonus 8 to the employee (or executive) 4, the employer 2 makes an X % (e.g., X=40) premium contribution of the bonus compensation 8 to the plan (depicted by arrow 3), whereas the employee makes a Y % premium contribution (e.g., Y=100-X=60) of the bonus compensation 8 to the plan (depicted by arrows 3 and 5). The employee and employer may each retain proportionate interest in the cash value and death benefits in the jointly-owned policy.

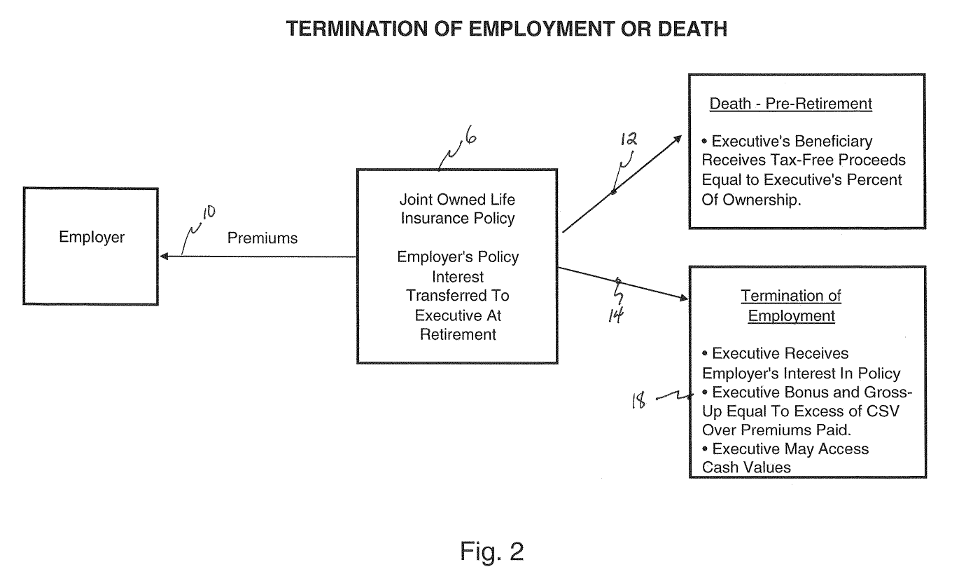

FIG. 2 depicts the benefits being passed to the employee beneficiary, after termination or death of the employee, for the plan of FIG. 1. Specifically, at termination of employment (with reference to box marked 18), the premium invested by the employer is refunded completely (or partially) to the employer (depicted by 10), whereas the interest generated in the policy from the employer premium investment is added to the total cash value of the employee premium (the total cash value of the employee premium may be obtained from the insurance policy ledger and as determined by the insurance provider) for determining the employee financial interest (or benefit). This employee financial interest is passed on to the employee/beneficiary upon termination of employment (depicted by 14).

Upon death of the employee (with reference to box marked 16) prior to retirement, the employee's beneficiary receives tax-free proceeds equal to employee's percent of ownership of the policy.

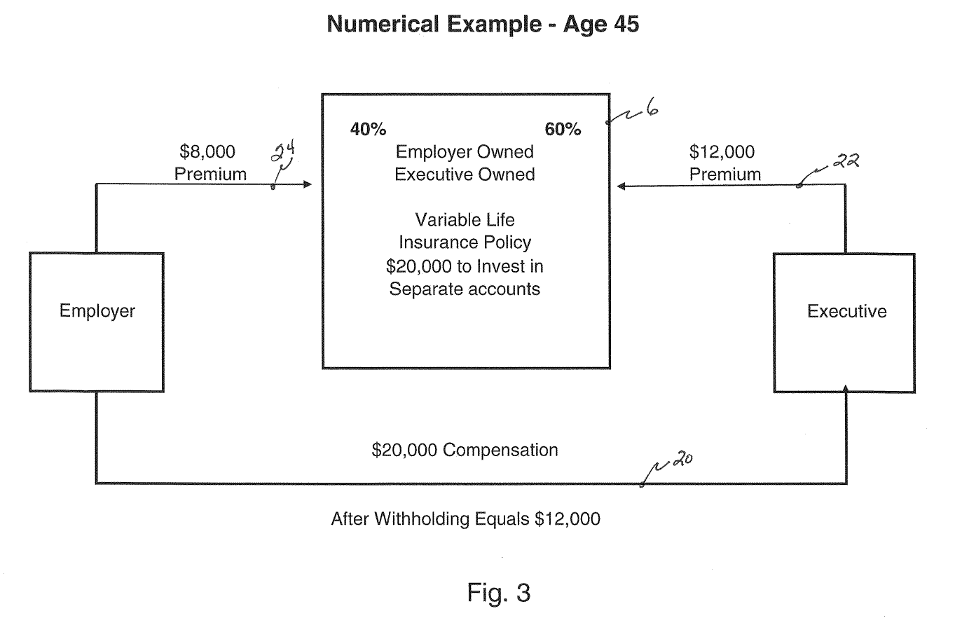

FIG. 3 is a numerical example of the premium structure for the plan, according to the embodiment of FIG. 1. Specifically, shown therein is a jointly owned policy 6 towards which the employee makes a 60% contribution of the $20,000 bonus compensation (viz., $12,000), while the employer makes a 40% contribution of the $20,000 bonus compensation (viz., $8,000) given to the employee.

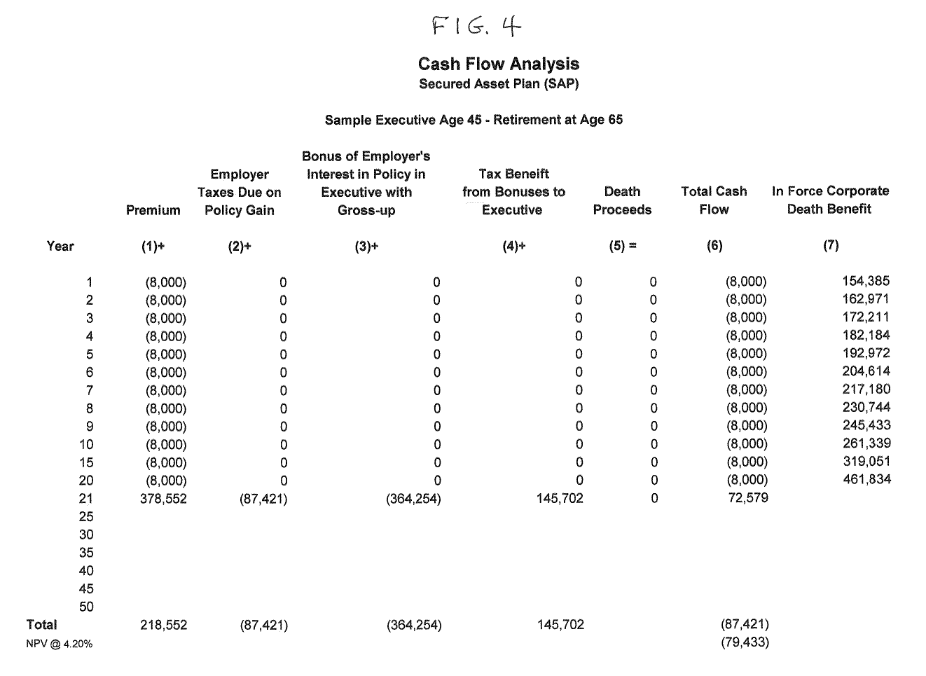

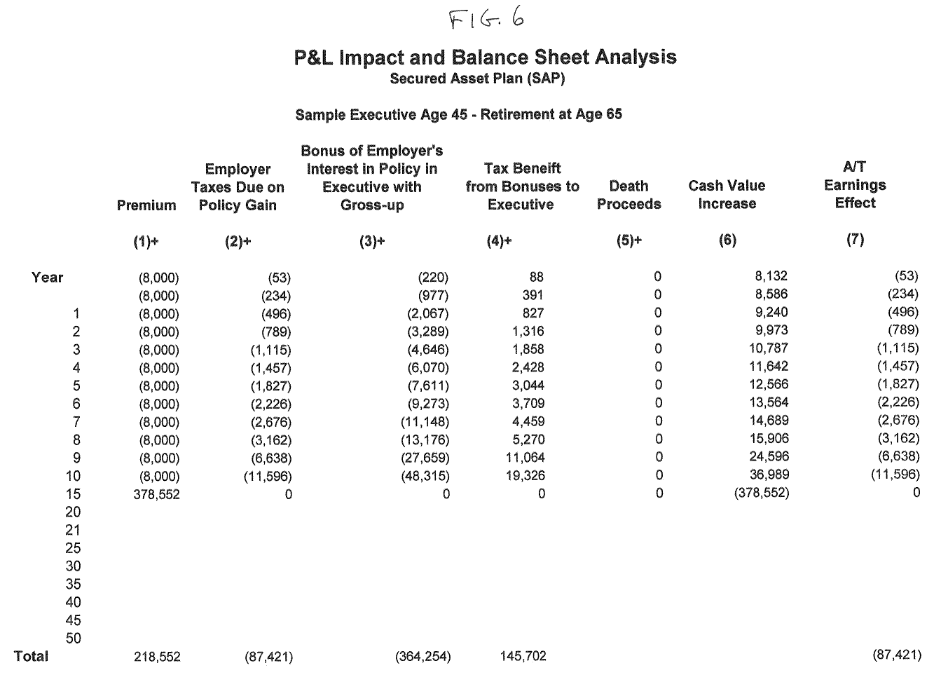

FIG. 4 is an exemplary spreadsheet of the cash flow analysis with the embodiment of FIG. 1. Specifically, shown therein in column 2 is a twenty year premium investment, by the employer into the employer-employee jointly owned policy 6 of FIG. 1, until retirement of the employee. For year 21, the amount $378,552 corresponds to the cash value increase of the employer investment in the policy (from column 6 in FIG. 6). The employer taxes that are due on policy gain (column 3) are determined by the difference in the total cash value of the employer investment in the policy and the total premium investment by the employer. Thus, assuming a employer tax rate of 40%, the employer taxes due on policy gain=($378,552-$8000*20)*0.4=218,552*0.4=$87,421. The bonus of employer's interest in the policy to the employee with gross-up (column 4) can be expressed as: 1 Bonus=(Employer Tax on Policy Gain) Employer Tax Rate * (1—Employee Tax Rate)

Thus, assuming an employee tax rate=employer tax rate=0.4, the bonus in column 4 is $87,421/[0.4*0.6]=$364,254. the tax benefit from bonus to the employee (column 5) is determined by the following equation:

Tax Benefit=Bonus*Employee Tax Rate

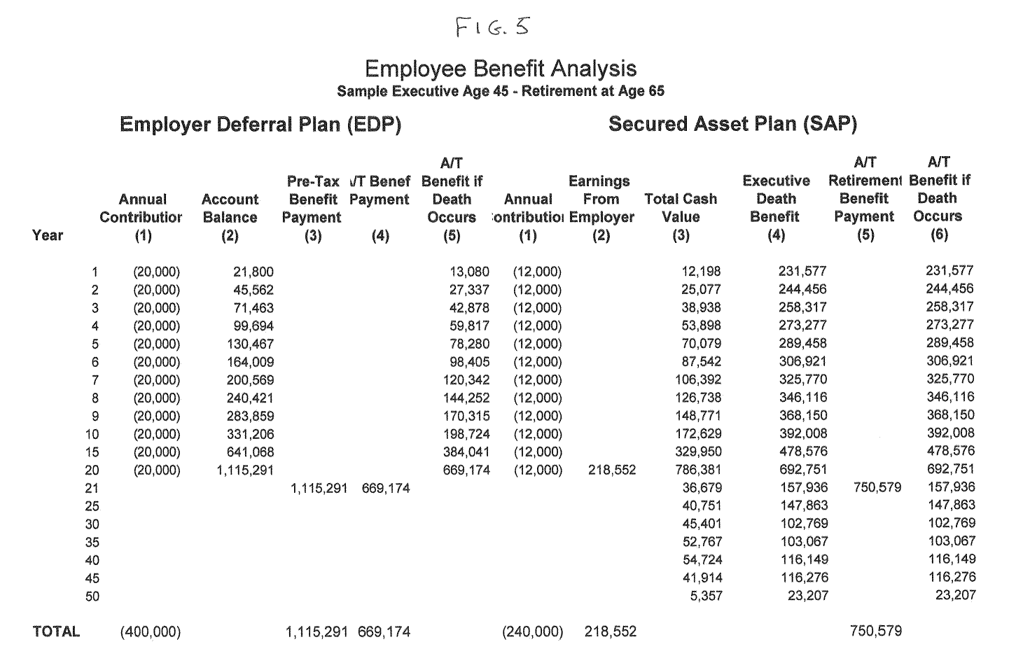

Thus, for the present numerical example, the tax benefit in column 5 is $364,254*0.4=$145,702. the total cash flow for the employer owned interest is then determined by the sum of the numbers, over columns 2, 3, 4, and 5. Thus, the total cash flow, in year 21, is $378,552-87,421-364,254+145702=$72,579. The total for the premium column 2 is $378,552-(Premium invested by the employer in the policy)=$378,552-$160,000=$218,552. This $218,552 will be added to the benefits of the employee part of the policy as shown in FIG. 5. The In Force Corporate Death Benefit, in column 8 is determined by the minimum non-MEC death benefit amount. Finally, at an NPV discount rate of 4.2% (viz., 7*(1—income tax rate) %=7*(1-0.4) %=4.2%), the total cash flow of ($79,433) is obtained.

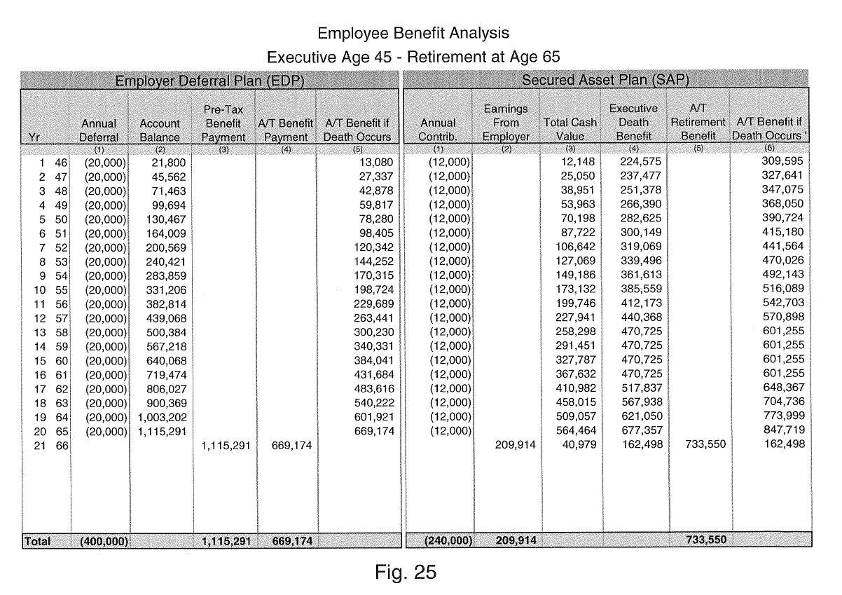

FIG. 5 is an exemplary spreadsheet of the employee benefit analysis with the embodiment of FIG. 1. Column 1 of the Secured Asset Plan (the system/the preferred embodiment) shows the annual contribution of $12,000 to the policy by the employee over a 20 year period. The total cash value of the employee premium is shown in column 3 of the Secured Asset Plan. The after-tax retirement benefit payment to the employee, at year 21, is determined from the earnings from the employer (i.e., $218,552 carried over from column 2 of FIG. 4) and the total cash value of the employee premium at year 20. Thus, in one aspect of the system, this is determined to be $750,579 in column 5. This number (i.e., $750,579) is determined by adding $218,552 with $786,381 and subtracting a residual value in the policy. In this example, the residual value, as determined from the policy ledger, is $254,354. Clearly, this number is much more that the one offered by the EDP (i.e., $669,174) for this example. In this example, the after tax benefit amount if death occurs at any year from year 1 through year 50 is equal to the employee death benefit amount as determined from the minimum non-MEC death benefit for that year. As can be seen, the after tax benefit amount is substantially higher than the one offered by the EDP. In the next embodiment, the after tax benefit is determined using a different formula (as will be explained later with reference to FIG. 25).

FIG. 6 is an exemplary spreadsheet of the P&L impact and balance sheet analysis with the embodiment of FIG. 1. Column 2 of the spreadsheet shows the annual premium of $8000 provided by the employer to the policy. The employer tax due on policy gain, in column 3, is determined by subtracting the premium from the cash value increase of column 7, and then applying the employer tax rate. Thus, in the example of year 1, $(8132-8000)*0.4=$53. Incidentally, the sum of the employer over all years can be seen to match the number in column 3 of FIG. 4. The tax benefit from the bonus to employee is determined from the bonus for that year multiplied with the employee tax rate. Thus, for example, for year 1, the tax benefit $220*0.4=$88. The after tax earnings effect, in column 8, is substantially the same as the employer taxes due on policy gain for any given year (viz., column 3).

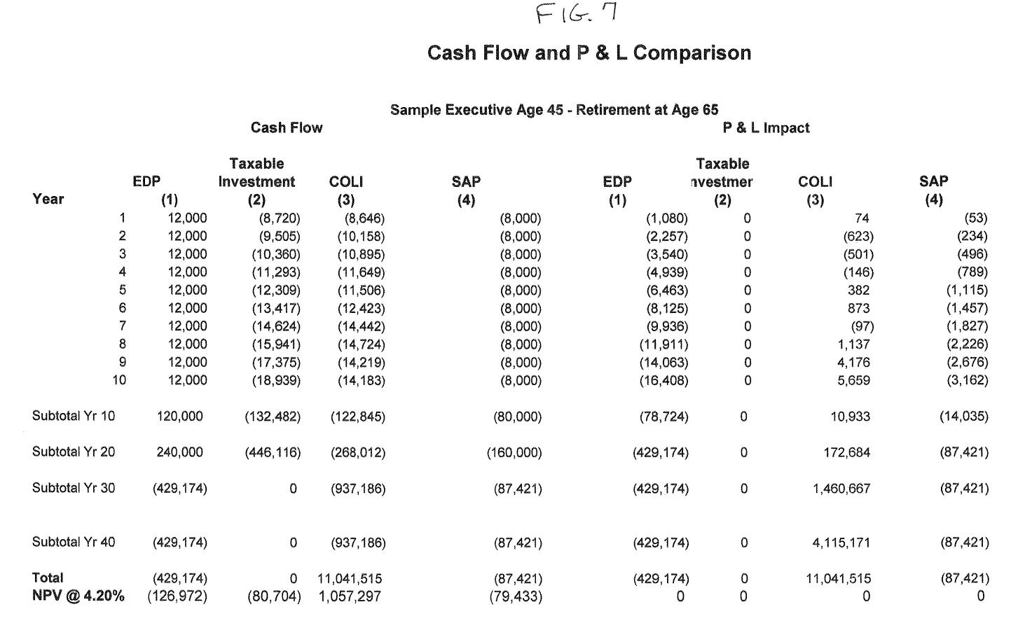

FIG. 7 is an exemplary spreadsheet for comparing the cash flow and P&L analysis between the embodiment of FIG. 1 and other benefit plans. This spreadsheet summarizes FIG. 4 and FIG. 6. Clearly, the advantages of the system can be seen though this spreadsheet.

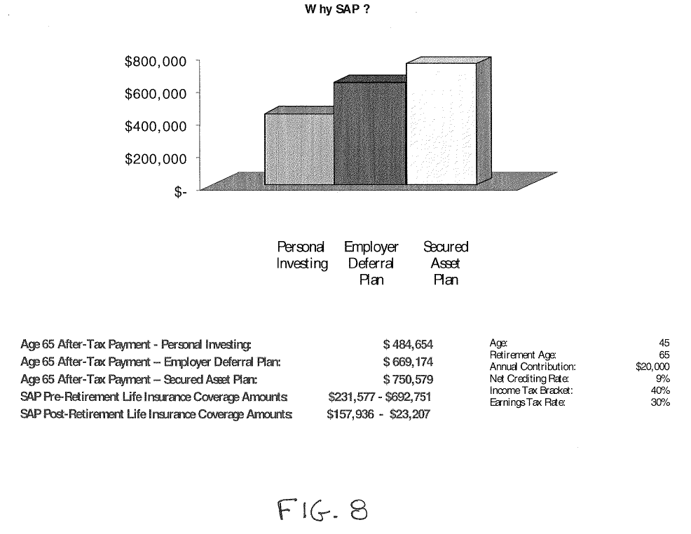

FIG. 8 is an exemplary chart depicting the advantages, for the employee, of the embodiment of FIG. 1 over other benefit plans. Again, the chart is a summary of the results obtained in FIG. 5. Clearly, the system is demonstrably superior to the EDP and the option of personal investing.

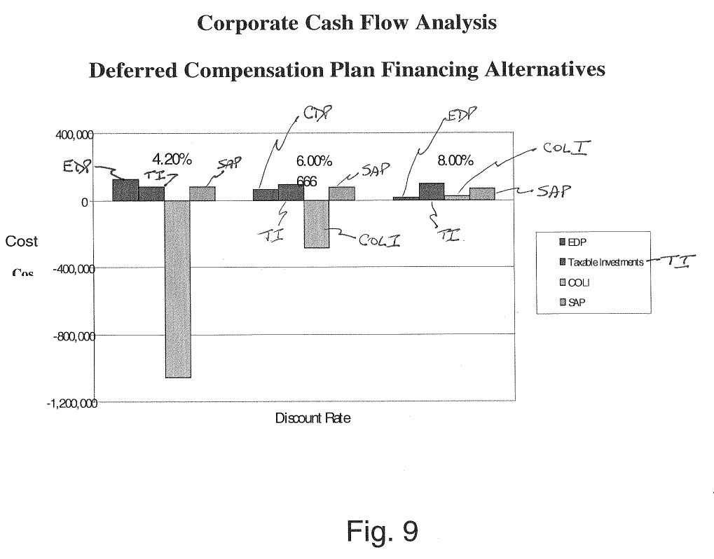

FIG. 9 is an exemplary chart depicting the advantages, in terms of the corporate cash flow analysis, of the embodiment of FIG. 1 over other benefit plans. The chart is a summary of the results in FIG. 4 for different NPV discount rates. Clearly, the system gives consistently better results than the other benefit methods.

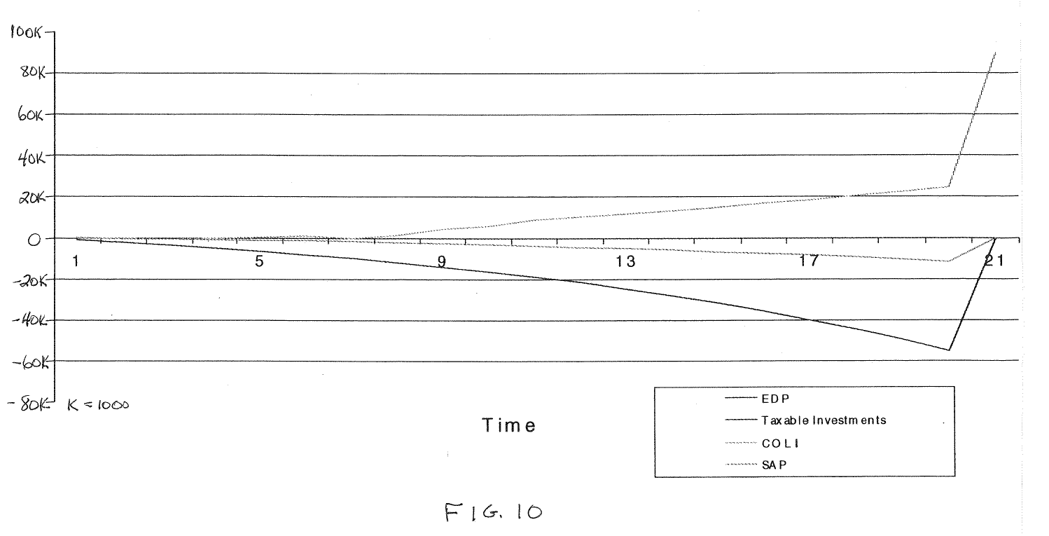

FIG. 10 is an exemplary chart depicting the advantages, in terms of the corporate P&L impact analysis, of the embodiment of FIG. 1 over other benefit plans over the 20 years.

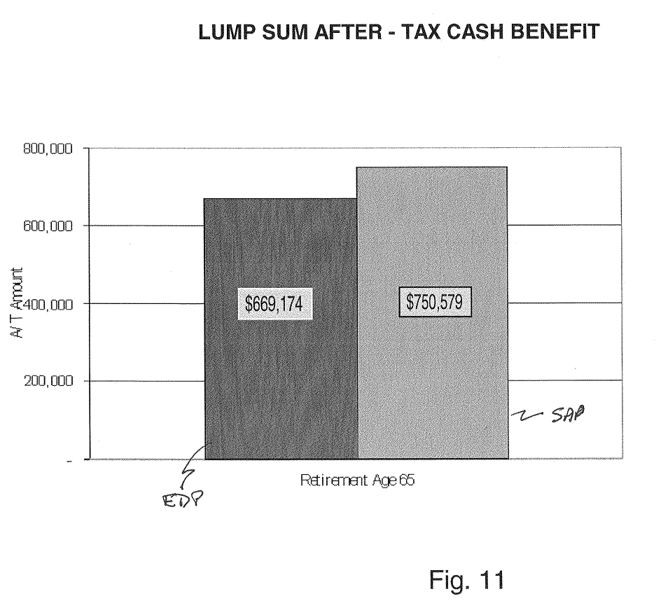

FIG. 11 is an exemplary chart depicting the advantages, in terms of the lump-sum after tax cash benefit to the employee, of the embodiment of FIG. 1 over other benefit plans. This chart is a summary of the results obtained in FIG. 5.

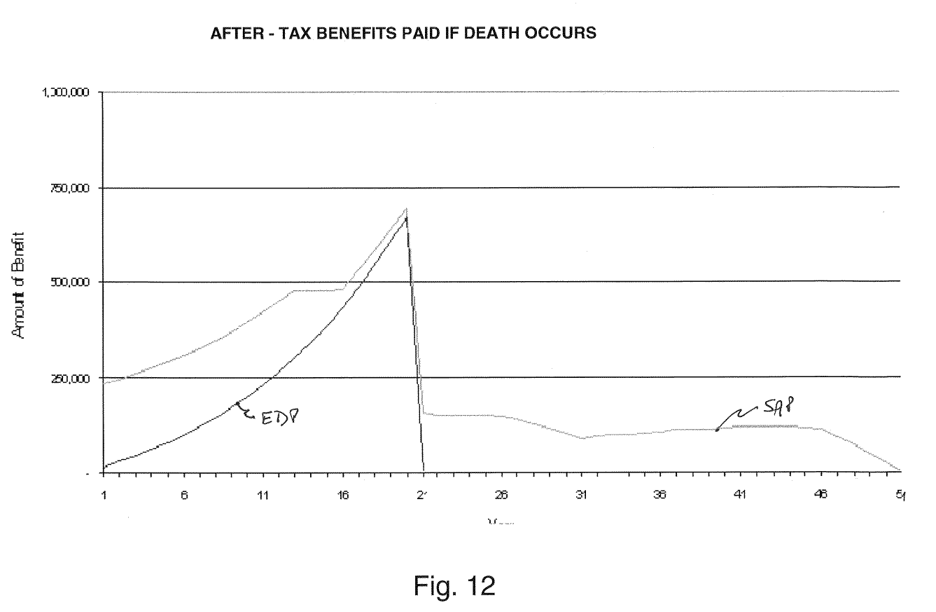

FIG. 12 is an exemplary graph depicting the advantages, in terms of after-tax benefit paid to the employee's beneficiary, of the embodiment of FIG. 1 over other benefit plans over the span of the duration of the policy. The results in this graph are as obtained in FIG. 5.

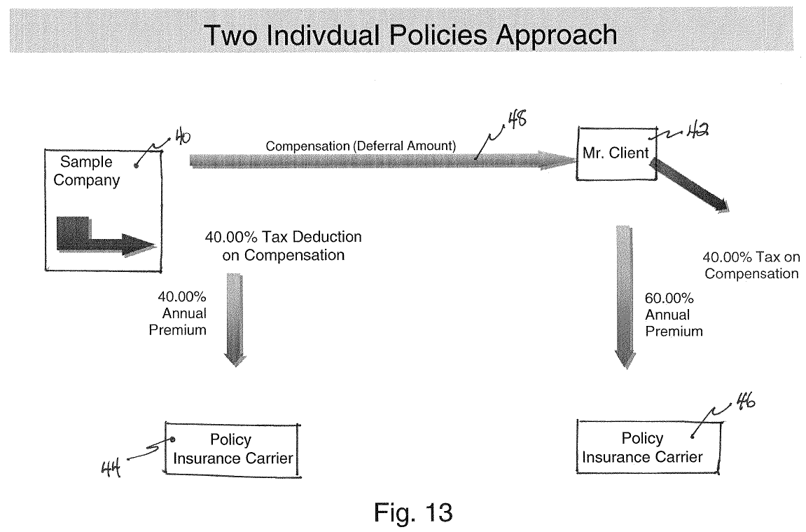

FIG. 13 is another embodiment of the system showing an employee benefit plan with a two-individual policies approach. Specifically, shown therein is another embodiment of the system where there are two individual policies, 44 and 46, for the employer and employee respectively. Generally, the premium structure of the plan may be designed such that, from the bonus 48 to the employee (or employee) 42, the employer 40 makes an X % (e.g., X=40) premium contribution of the bonus compensation to its policy 44, whereas the employee 42 makes a Y % premium contribution (e.g., Y=100-X=60) of the bonus compensation 48 to his/her policy 46. The employee and employer retain their interest in the cash value and death benefits of their individually owned policies.

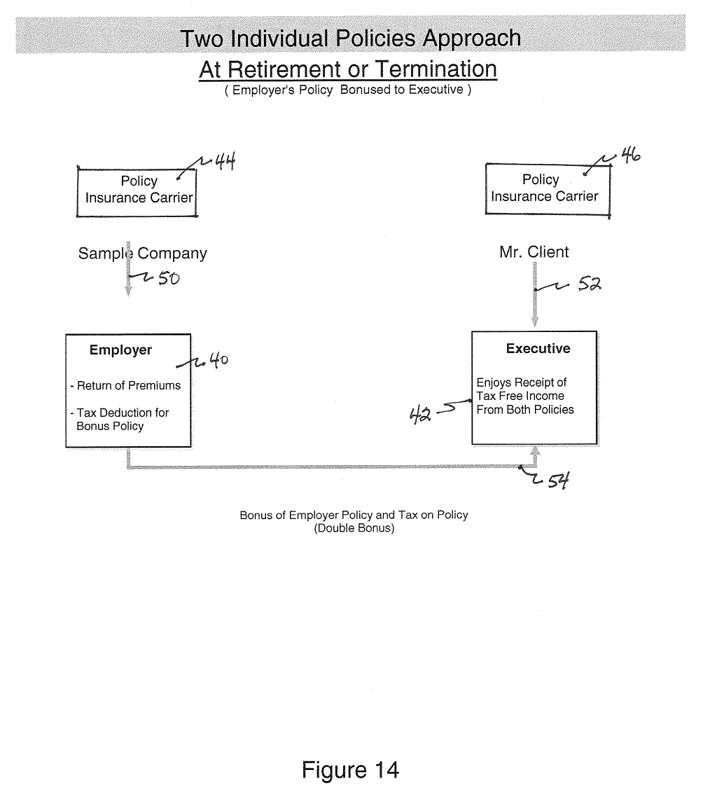

FIG. 14 depicts the benefits being passed to the employee beneficiary after termination or retirement of the employee for the plan of FIG. 13. Specifically, at termination of employment, the premium invested by the employer is refunded completely (or partially) to the employer (depicted by 50). Furthermore, a tax deduction may be applied for with the IRS for this bonus policy. The employee, in turn, enjoys receipt of tax free income from the employer policy (depicted by arrow 54) as well as from his/her policy (depicted by arrow 52). This constitutes a double bonus corresponding to the bonus of employer policy and tax on the policy.

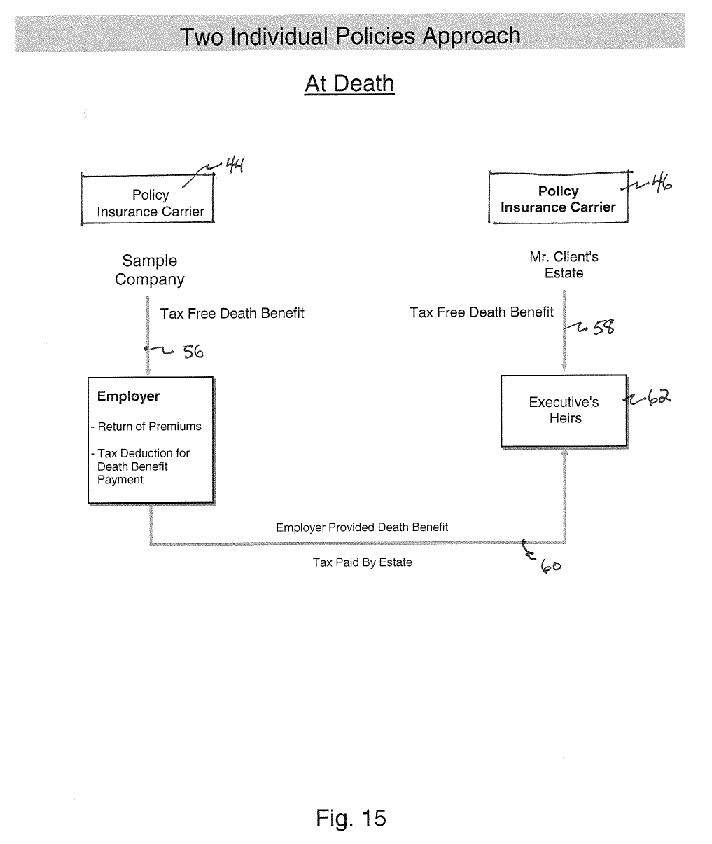

FIG. 15 depicts the benefits being passed to the employee beneficiary, 62, after death of the employee under the plan of FIG. 13. As depicted by 56, upon death of the employee, the employer is refunded the portion of its invested premiums and is allowed a tax deduction for the death benefit payment to the employee's beneficiary. The employee's beneficiary (or employee heir's) receives tax free death benefit, 58, from the employee's policy. 46 Any death benefit paid by the employer will be taxable to the recipients (depicted by 60). Any tax on the death benefit amount 60 may be paid directly by the estate of the employee or the recipients.

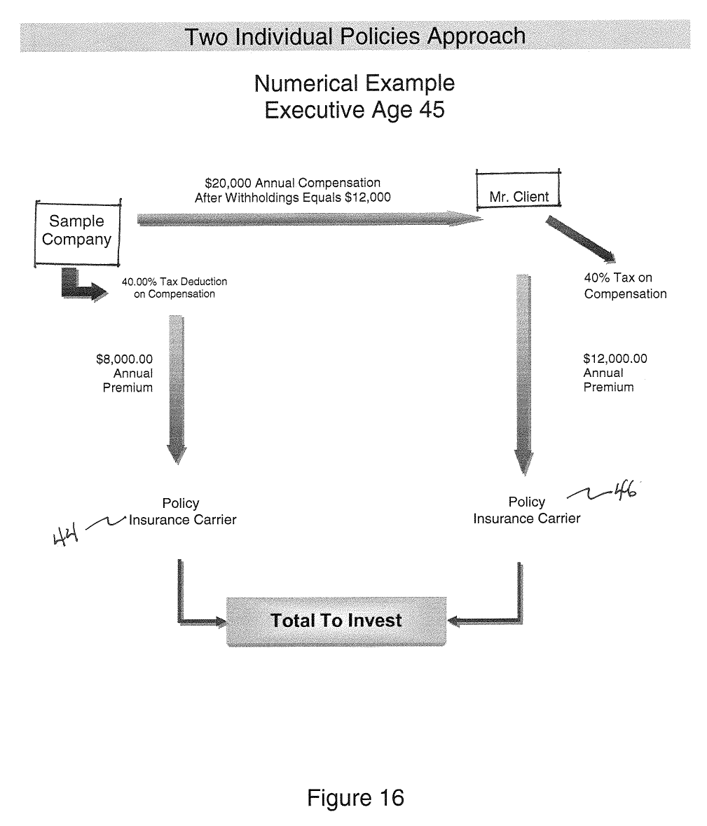

FIG. 16 is a numerical example of the premium investment structure of the plan of FIG. 13. Specifically, shown therein are two individual policies 44 and 46 for the employer and employee respectively. The employer makes an annual premium contribution of 40% of the $20,000 compensation (viz., $8000) in it's own policy 44. The employee makes the remaining 60% annual contribution to his/her own policy 46.

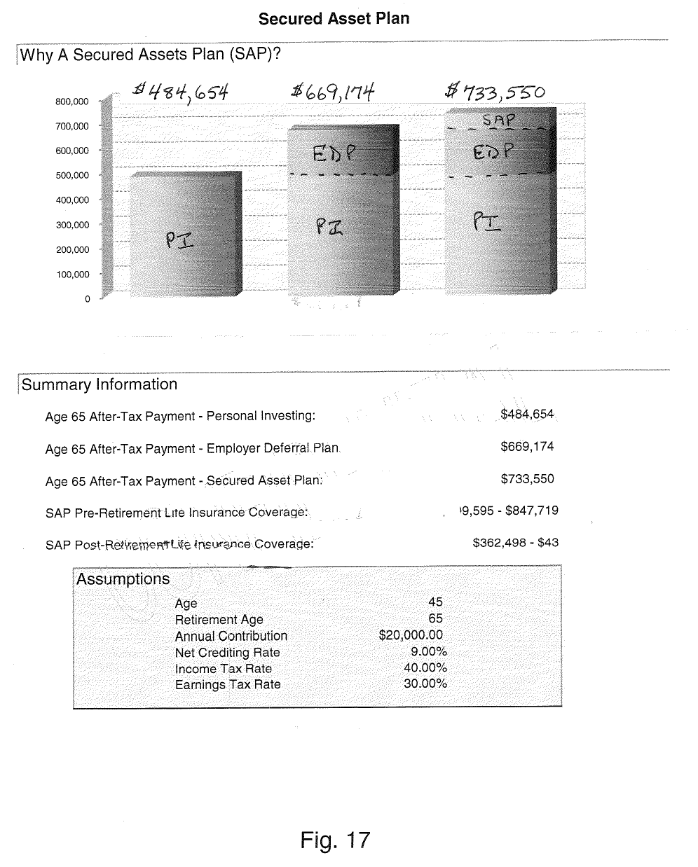

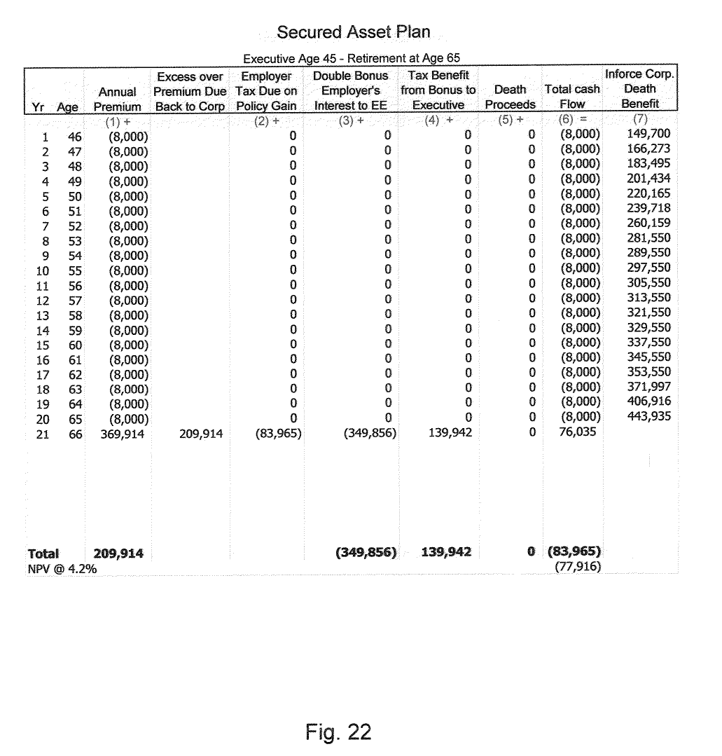

FIGS. 17-21 depict exemplary charts of the advantages, for the employee, of the embodiment of FIG. 13 over other benefit plans. The numerical values in FIGS. 17-20 are computed in the same fashion as were done in reference to FIGS. 8-11 and will not be explained in detail (see paragraphs [0057]-[0064] for details). For completeness, these values are determined in FIGS. 22-25.

The chart of FIG. 21 for the after-tax benefits paid to the employee's beneficiary is determined in an alternative manner and as referenced to FIG. 25.

Specifically, FIG. 25 is an exemplary spreadsheet for comparing the employee benefit analysis between the embodiment of FIG. 13 and the EDP. The after tax death benefit in column 6, for the system, is determined by the following formula:

After Tax Death Benefit Amount=A+[(B-C)*(1-D)]

where, A is the Employee Death Benefit amount (column 4 of the SAP table) as determined from the minimum non-MEC death benefit amount; B is the In Force Corporate Death Benefit amount (determined from the minimum non-MEC amount) of FIG. 22, column 9; C is the employer annual premium, and D is the employee tax rate. Thus, for an employee tax rate of 0.4, at year 1, the after tax death benefit=$224,575+[(149,700-8000)*(1-0.4)]=$30-9,595.

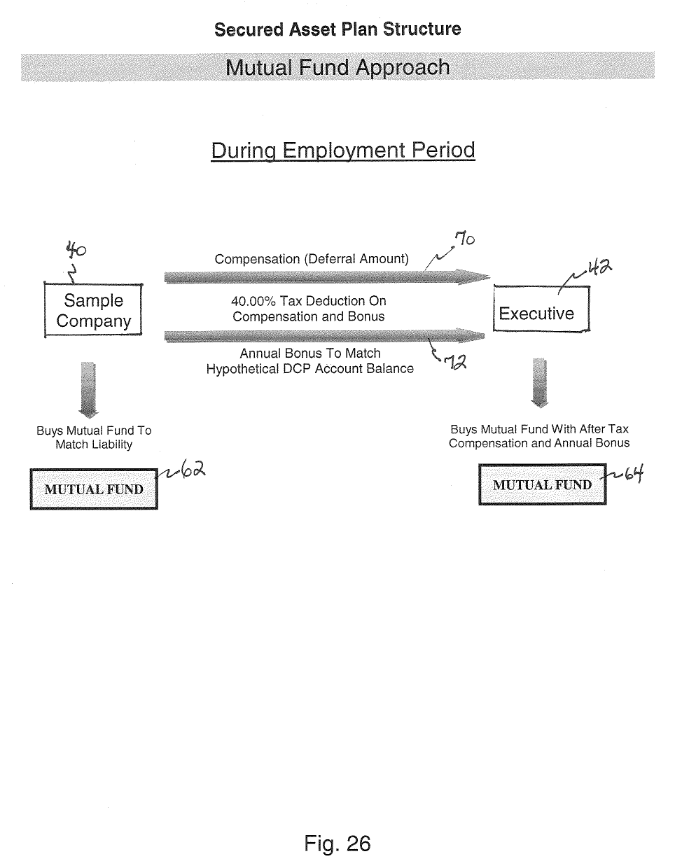

FIG. 26 is another embodiment of the system showing an employee benefit plan with a mutual fund approach. There are two individual mutual fund investments, 62 and 64, for the employer and employee respectively. Generally, the fund contribution structure may be designed such that the employee 42 buys into the mutual fund with the after tax compensation (depicted as 70) and/or the annual bonus 72 provided by the employer 40. The employee and employer may each retain their respective interests in the values of their respective mutual funds.

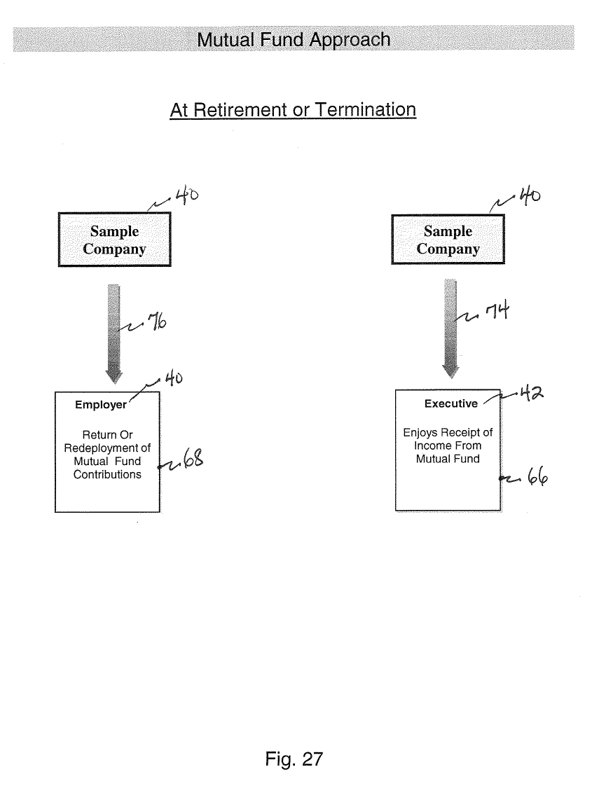

FIG. 27 depicts the benefits being passed to the employee beneficiary after termination or retirement of the employee for the plan of FIG. 26. Specifically, at termination of the employee, the fund invested by the employee may be refunded completely (or partially) to the employer (depicted by 76), or it may be redeployed in other profitable mutual funds. The employer, in turn, enjoys receipt of income from the employer fund account (depicted by arrow 54) as well as from his/her fund account (generally depicted by arrow 74).

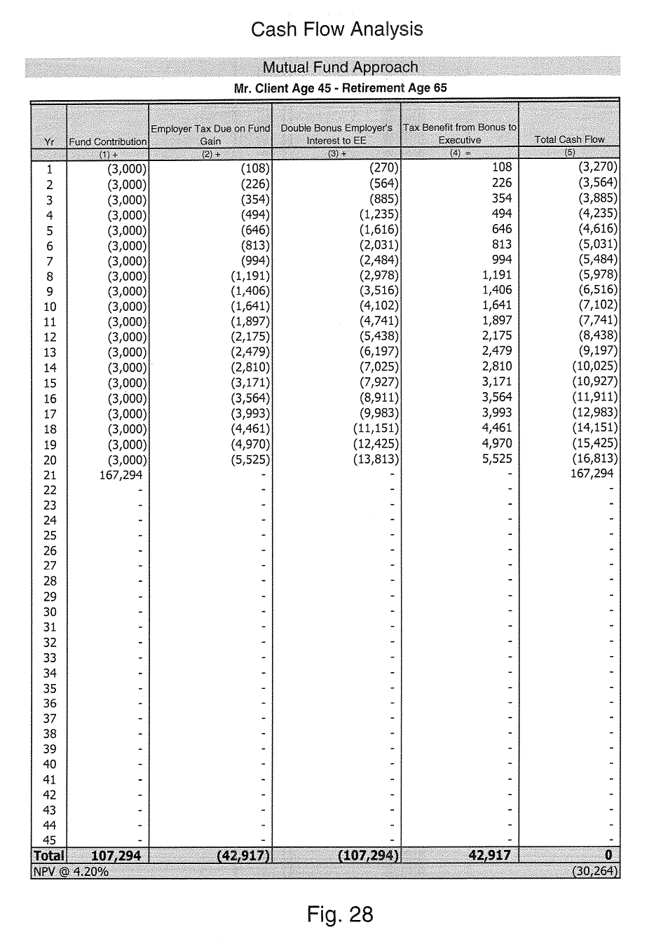

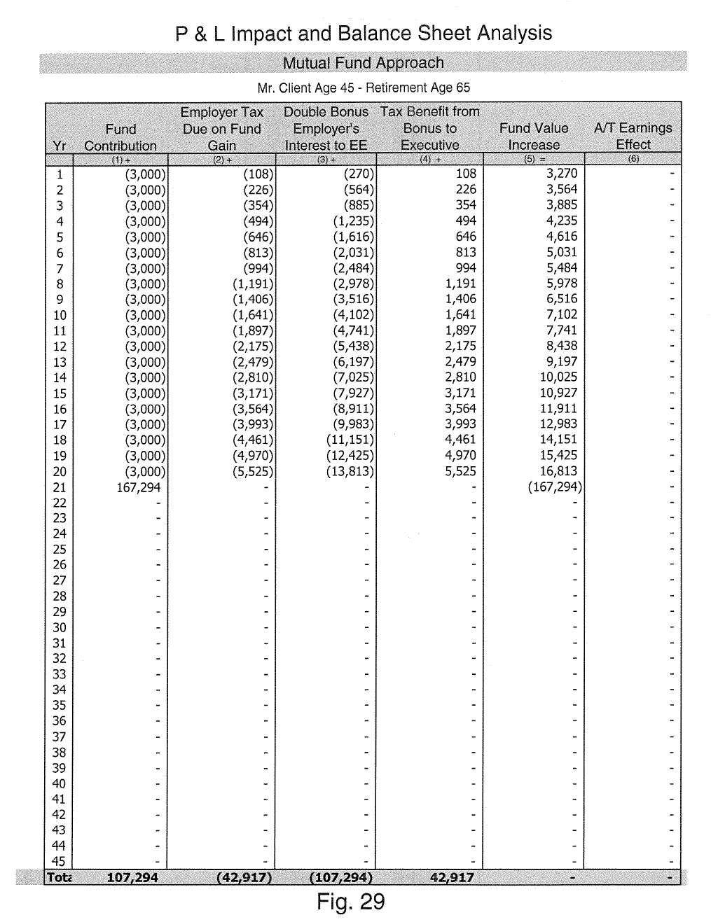

FIG. 28 is an exemplary spreadsheet of the cash flow analysis with the embodiment of FIG. 26, whereas FIG. 29 is an exemplary spreadsheet of the P&L impact and balance sheet analysis with the embodiment of FIG. 26. The following assumptions are used for determining various numerical values within the spreadsheet.

Corporate Tax Rate: Assumed to be 40%,

Employee Income Tax Rate (personal income tax rate for the employee): Assumed to be 40%,

Employee Capital Gains/Dividend Tax Rate (tax rate that applies to long-term capital gains and dividends): Assumed to be 15%,

Mutual Fund Earnings Rate (rate of earnings assumed for the mutual fund investment): Assumed to be 9%,

Mutual Fund Portfolio Turnover (measures the extent to which mutual fund holdings are bought and sold): Assumed to 100%/year,

Employee Deferral Amount (the amount the employee elects to defer into the plan): Assumed to be $20,000,

Salary Scale (assumed annual increase in employee compensation): Assumed to be 0%,

Payout Schedule (the number of payments the employee elects to receive beginning at retirement): Assumed as 1 lump sum payment.

The following intermediate equations are required to determine the numerical values in FIGS. 28-29.

A1. Employer Mutual Fund Account Value: This is the end of year account value of the mutual fund investment. At time zero the Mutual Fund Account Value is equal to 0, whereas for subsequent years, it is expressed as:

G=(H+FC)*(1+ER)

where, G is the Mutual Fund account value, H is the Mutual Fund Account Value at end of previous year, FC is the Fund Contribution, and ER is the Mutual Fund Earnings Rate.

A2. Employer Mutual Fund Earnings: This is the annual earnings in the mutual fund investment and is expressed as:

J=(H+FC)*ER

A3. Deferral Plan Account Value: This is the employee's end of year deferral plan account value. At time zero the Deferral Plan Account Value is equal to 0. For the years from employee age to employee retirement age, this value is computed as:

[Deferral Plan Account Value at End of Previous Year+Employee Deferral Amount]*[1+Deferral Plan Earnings Rate]

For the years corresponding to employee retirement age+1 onwards, the deferral plan account value is set to $0.

A4. Employee Mutual Fund Account Value: This is the end of year account value of the employee's mutual fund investment. At time zero the Employee Mutual Fund Account Value is set to 0. For subsequent years, it is expressed as:

[Employee Mutual Fund Account Value at End of Previous Year+Annual Fund Contribution]*[1+Mutual Fund Earnings Rate]

The following equations determine each column entry in FIGS. 28-29:

B1. Fund Contribution: This is the amount the employer will contribute to the mutual fund investment and is calculated as:

Fund Contribution=(Employee Capital Gains & Dividend Tax Rate*Employee Deferral Amount)

B2 . Employer Tax Due on Fund Gain: This is the amount the employer will pay in taxes due to growth in the mutual fund asset, and is calculated as:

Employer Tax due on Fund Gain=−[Mutual Fund Account Value for Current Year-Mutual Fund Account Value of Previous Year-Fund Contribution]* Corporate Tax Rate*Mutual Fund Portfolio Turnover.

B3. Double Bonus Employer's Interest to EE (Note: EE denotes Employee): The employer may bonus, to the employee, all earnings the employer makes on the mutual fund investment plus any taxes the employee will have to pay on the bonus. Thus,

Double Bonus Employer's Interest to EE=-Mutual Fund Earnings/(1 -Employee Income Tax Rate).

B4. Tax Benefit from Bonus to Employee: This is the tax deduction the employer can take for paying the employee, and is determined as:

Tax Benefit from Bonus to Employee=Double Bonus Employer's Interest to EE*Corporate Tax Rate

B5. Total Cash Flow: This is determined as,

Total Cash Flow=Fund Contribution+Employer Tax due on Fund Gain+Double Bonus Employer's Interest to EE+Tax Benefit from Bonus to Employee.

B6. Fund Value Increase: This is the increase in the mutual fund investment for the year, and is determined as:

Fund Value Increase=Mutual Fund Account Value at the end of current year-Mutual Fund Account Value at the end of previous year.

B7. After-Tax (A/T) Earnings Effect: This is calculated as:

A/T Earnings Effect=Fund Contribution+Employer Tax due on Fund Gain+Double Bonus Employer's Interest to EE+Tax Benefit from Bonus to Employee+Fund Value Increase.

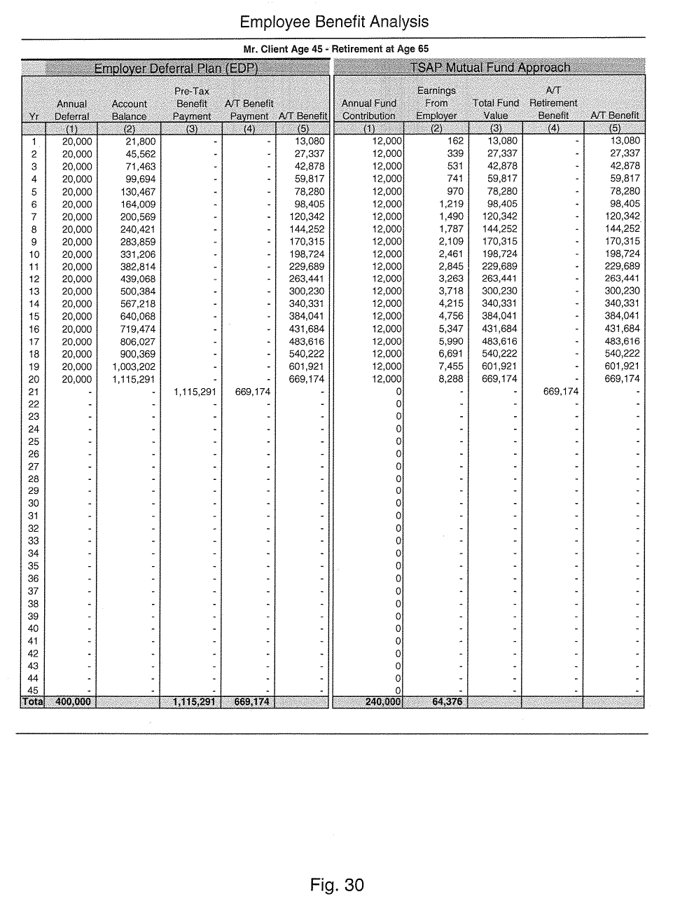

FIG. 30 compares the employee benefit analysis between the mutual fund approach and the EDP methods (with the mutual fund earnings rate of 9%). Clearly, the advantages of this method can be immediately seen by comparing the Mutual Fund Approach against EDP.

Specifically, for the embodiment of the Mutual Fund approach, the following equations are used to determine each entry in FIG. 30.

C1. Annual Fund Contribution: Annual Fund Contribution=−[Employee Deferral Amount]* (1 -[Employee Income Tax Bracket])

Thus, for example, based on a $20,000 Employee Deferral Amount and a 40% income tax bracket, the Annual Fund Contribution is $(−20000)*(1-0.4)=$−12,000.

C2. Earnings from Employer: This is the annual bonus of the employer's earnings to the employee, and is computed as:

Earnings from Employer=−[Double Bonus Employer's Interest to EE]*(1-[Employee Income Tax Bracket])

The Double Bonus Employer's Interest to EE figure comes from the Mutual Fund SAP Cash Flow Analysis (viz., column 4 in FIG. 28). Thus, for example in year 1 , the Earnings from Employer=$−[270]*(1-[0.4])=$(162).

C3. Total Fund Value: This is the same as the Employee Mutual Fund Account Value under Intermediate calculated values (viz., equation corresponding to A4, defined above). Thus, for example in year 1, the Total Fund Value=[Employee Mutual Fund Account Value at end of previous year+Annual Fund Contribution]* [1 +Mutual Fund Earnings Rate] =$[12,000]*[1+0.09]=$13,080.

C4. A/T Retirement Benefit: For all ages less than or equal to the Employee Retirement Age the A/T Retirement Benefit is set to zero. At the age Employee Retirement Age+1 year, the After Tax (A/T) Retirement Benefit is equal to the Account Balance (i.e., Total Fund Value) of the previous year, whereas for all ages greater than Employee Retirement Age+1 year the A/T Retirement Benefit is equal to 0.

C5. A/T Benefit if Death Occurs: This is equal to the Total Fund Value in all years.

With regards to FIG. 30, the plan provides for the creation of a hypothetical deferred compensation account to be administered by the employer. The employer contribution (i.e., column 2, Earnings from the Employer, in the Mutual Fund Approach spreadsheet) to the employee's mutual fund account is determined with reference to the employee's hypothetical deferred compensation account (i.e., column 5 of the EDP spreadsheet in FIG. 30). To the extent that there is a shortfall in the account balance of the employee's mutual fund account, on an after tax basis, when compared to the hypothetical account, the employer's contribution to the employee's mutual fund account will be equal to such shortfall.

It is to be understood that other embodiments may be utilized and structural and functional changes may be made without departing from the respective scope of the system as described, and the inventions as claimed. Possible modifications to the method include, but are not limited to, partnership interests, variable annuities, derivative investments, real estate and other asset classes. The method will allow the substitution of any asset for the life insurance or mutual fund/managed account. The system can calculate the relative contributions of the employer and employee based on the investment results of the underlying investments.

What is claimed is:

1. A method, implemented on a computer, for providing periodic supplemental income benefits, from an employer to an employee, in accordance with an employer created structure, whose purpose is to replicate the results of a deferred compensation plan normally held by the employer and at a risk to the employee, the results of said simulated plan being compared to the actual investments and performance of a plan individually owned by the employee, the employer then equalizing those results to equal the employee after-tax performance of the simulated plan, comprising:
Creating for the employee a hypothetical deferred compensation account and storing same in computer memory,
Tracking employee's hypothetical contributions, investment allocations and investment gains and losses to said hypothetical deferred compensation account as a basis for determining employee's periodic cash bonus benefit,
Periodically calculating employee's actual contributions, investment allocations and investment gains and losses, on an after-tax basis, invested in a real account owned by the employee, then contrasting the balance of said real account to the after-tax balance of said hypothetical deferred compensation account,
Equalizing the account balances of said hypothetical deferred compensation account and the employee real account, with current compensation to the employee, to create the same net effect as if he or she had a real deferred compensation plan held by the employer.

2. The computer implemented method according to claim 1, wherein the annual mutual fund contribution=−[g1]*(1−g2), wherein g1 is a contribution amount provided by the employee into the mutual fund account and g2 is an employee income tax rate.

3. The computer implemented method according to claim 2 wherein the employee mutual fund account value at retirement=(k1+k2)*(1+k3), wherein k1 is an employee mutual fund account value in the year prior to retirement, k2 is annual mutual fund contribution, and k3 is a mutual fund earnings rate.

4. The computer implemented method according to claim 1, wherein said accounts are implemented through mutual funds.
